(19) United States
(12) Patent Application Publication
(10) Pub. No.: US 2024/0370741 A1
(43) Pub. Date: Nov. 7, 2024

(54) MACHINE LEARNING MODEL WATERMARKING THROUGH FAIRNESS BIAS

(71) Applicant: SAP SE, Walldorf (DE)

(72) Inventors: Sofiane Lounici, Le Cannet (FR); Slim Trabelsi, Biot (FR)

(21) Appl. No.: 18/312,287

(22) Filed: May 4, 2023

(51) Int. Cl. G06N 5/022

(52) U.S. Cl. CPC G06N 5/022

(57) ABSTRACT

A machine learning model is watermarked through fairness bias. To do this, an original set of labeled data is obtained and clustered into a plurality of groups using a clustering algorithm. Labels for data in a subset of the groups are modified, inserting fairness bias into the subset. A machine learning model is trained based on the subset of data labeled using the modified labels and the original set of data outside of the subset labeled using the original set of labels. The machine learning model trained as such exhibits the fairness bias when classifying input data belonging to subset of the plurality of groups. A model exhibiting the fairness bias for input data belonging to the subset is a watermark of a machine learning model that was trained using the modified labels for the subset determined based on the subgroup algorithm. The watermark is usable to determine ownership.

### BACKGROUND

The present disclosure pertains to machine learning and in particular to machine learning model watermarking through fairness bias.

Machine learning models are becoming widely used in industry. For example, machine learning models are used to automate repetitive tasks and identify precise patterns in a corpus of data. There are various machine learning models trained for different use cases and applications. Some of these machine learning models remain internal to the company or organization that created them while others are published though machine learning platforms (e.g., providing an application programming interface) in order to enable the external use. With the increasing development of machine learning models, a need for intellectual property protection of such models has grown. For this purpose, certain prior works suggest leveraging backdoor attacks as a defensive strategy to embed a watermark into a model such that the owner can be identified based on the watermark. However, this technique is vulnerable to attackers when it comes to verify the ownership, especially over repeated verification attempts.

The present disclosure addresses these issue and others, as further described below.

### SUMMARY

Some embodiments provide a computer system. The computer system comprises one or more processors and one or more machine-readable medium coupled to the one or more processors. The one or more machine-readable medium storing computer program code comprising sets instructions executable by the one or more processors to obtain an original set of labeled data including original data and an original set of labels classifying each piece of the original data. The instructions being further executable by the one or more processors to cluster the original set of labeled data into a plurality of groups using a clustering algorithm. The instructions being further executable by the one or more processors to determine a subset of the plurality of groups. The instructions being further executable by the one or more processors to modify labels for data in the subset of the plurality of groups to obtain modified labels for the data in the subset. The modifying of the labels for data in the subset inserts fairness bias into the subset. The instructions being further executable by the one or more processors to train a machine learning model based on the subset of data labeled using the modified labels and the original set of data outside of the subset labeled using the original set of labels. The machine learning model will exhibit the fairness bias when classifying input data belonging to subset of the plurality of groups. This exhibiting of the fairness bias for input data belonging to the subset is a watermark of the machine learning model that was trained using the modified labels for the subset.

Some embodiments provide a non-transitory computer-readable medium storing computer program code. The computer program code comprises sets of instructions to obtain an original set of labeled data including original data and an original set of labels classifying each piece of the original data. The computer program code further comprises sets of instructions to cluster the original set of labeled data into a plurality of groups using a clustering algorithm. The computer program code further comprises sets of instructions to determine a subset of the plurality of groups. The computer program code further comprises sets of instructions to modify labels for data in the subset of the plurality of groups to obtain modified labels for the data in the subset. The modification of the labels for data in the subset inserting fairness bias into the subset. The computer program code further comprises sets of instructions to train a machine learning model based on the subset of data labeled using the modified labels and the original set of data outside of the subset labeled using the original set of labels. The machine learning model will exhibit the fairness bias when classifying input data belonging to subset of the plurality of groups. The exhibiting of the fairness bias for input data belonging to the subset is a watermark of the machine learning model that was trained using the modified labels for the subset.

Some embodiments provide a computer-implemented method. The method comprises obtaining an original set of labeled data including original data and an original set of labels classifying each piece of the original data. The method further comprises clustering the original set of labeled data into a plurality of groups using a clustering algorithm. The method further comprises determining a subset of the plurality of groups. The method further comprises modifying labels for data in the subset of the plurality of groups to obtain modified labels for the data in the subset. The modifying of the labels for data in the subset inserts fairness bias into the subset. The method further comprises training a machine learning model based on the subset of data labeled using the modified labels and the original set of data outside of the subset labeled using the original set of labels. The machine learning model exhibits the fairness bias when classifying input data belonging to subset of the plurality of groups. The exhibiting of the fairness bias for input data belonging to the subset is a watermark of the machine learning model that was trained using the modified labels for the subset.

The following detailed description and accompanying drawings provide a better understanding of the nature and advantages of the present disclosure.

### BRIEF DESCRIPTION OF THE DRAWINGS

FIG. 1 shows a diagram of watermark embedding, machine learning model training, and watermark evaluation, according to an embodiment.

FIG. 2 shows a diagram of a method for embedding and verifying a watermark using fairness bias, according to an embodiment.

FIG. 3 shows a diagram of a machine learning model watermarking algorithm including an embedding phase and a verification phase, according to an embodiment.

FIG. 4 shows a diagram of a machine learning platform that installs and verifies machine learning model watermarks, according to an embodiment.

FIG. 5 shows a diagram of hardware of a special purpose computing machine for implementing systems and methods described herein.

### DETAILED DESCRIPTION

In the following description, for purposes of explanation, numerous examples and specific details are set forth in order to provide a thorough understanding of the present disclosure. Such examples and details are not to be construed as unduly limiting the elements of the claims or the claimed subject matter as a whole. It will be evident, based on the language of the different claims, that the claimed subject matter may include some or all of the features in these examples, alone or in combination, and may further include modifications and equivalents of the features and techniques described herein.

In the figures and their corresponding description, while certain elements may be depicted as separate components, in some instances one or more of the components may be combined into a single device or system. Likewise, although certain functionality may be described as being performed by a single element or component within the system, the functionality may in some instances be performed by multiple components or elements working together in a functionally coordinated manner. In addition, hardwired circuitry may be used independently or in combination with software instructions to implement the techniques described in this disclosure. The described functionality may be performed by custom hardware components containing hardwired logic for performing operations, or by any combination of computer hardware and programmed computer components. The embodiments described in this disclosure are not limited to any specific combination of hardware circuitry or software. The embodiments can also be practiced in distributed computing environments where operations are performed by remote data processing devices or systems that are linked through one or more wired or wireless networks. As used herein, the terms “first,” “second,” “third,” “fourth.” etc., do not necessarily indicate an ordering or sequence unless indicated. These terms, as used herein, may simply be used for differentiation between different objects or elements.

As mentioned above, machine learning models are becoming widely used in industry. For example, machine learning models are used to automate repetitive tasks and identify precise patterns in a corpus of data. There are various machine learning models trained for different use cases and applications. Some of these machine learning models remain internal to the company or organization that created them while others are published though machine learning platforms (e.g., providing an application programming interface) in order to enable the external use. With the increasing development of machine learning models, a need for intellectual property protection of such models has grown. For this purpose, certain prior works suggest leveraging backdoor attacks as a defensive strategy to embed a watermark into a model such that the owner can be identified based on the watermark.

Back-door based watermarking is vulnerable to attackers when it comes to verifying ownership, especially over repeated verification attempts. For example, application programming interface (API) monitoring may be used to periodically verify whether an API endpoint is deploying a stolen model or not. In such applications, a model owner may frequently send trigger inputs to a suspect model. In backdoor-based watermarking techniques, the verification of the triggers results in their publication of which then requires the generation of new triggers, adding overhead to the model owner. An adversary may be able to distinguish trigger inputs from legitimate inputs can behave accordingly to remain undetected. Thus, by increasing the number of verification queries, the model owner discloses ownership information contained in the trigger inputs more easily, which is a vulnerability for the secrecy of the watermark. Certain trigger generation techniques have been developed to be indistinguishable from original data. However, the multiplication and the frequency of verification queries for a given watermarked model constitutes a threat to ownership.

Fairness bias, also called algorithmic bias or algorithmic discrimination, describes systemic errors in an algorithm which creates unfair results i.e., to privilege arbitrary groups in data over others. Given its importance in various fields of artificial intelligence such as justice or healthcare and its tendency to reinforce social bias of race, gender, sexuality and ethnicity, fairness bias has been addressed in legal frameworks such as the General Data Protection Regulation. Similar to backdoor attacks, fairness bias is sometimes an unwanted behavior in building machine learning models; however, it is possible to leverage this weakness into a strength in order to identify machine learning models according to their fairness bias.

This disclosure provides an improved watermarking technique based on fairness attacks to mark machine learning model and to enable secure ownership verification. Unlike back-door based watermarking, fairness bias based watermarking does not use trigger inputs which are different or separate from legitimate input data. Instead, fairness bias is intentionally introduced into the model by modifying labels, thereby modifying model output, for particular subsets (e.g., sub-populations). This fairness bias is usable to uniquely identify the model, and therefore ownership. Unless backdoor based watermarking, verification input queries do not contain ownership information and do not need to be protected, advantageously allowing for frequent ownership verification (e.g., using API monitoring).

Instead of keeping triggers secret, as in backdoor based watermarking, fairness bias based watermarking as disclosed herein using a secret clustering algorithm to cluster labeled data into a plurality of groups, of which a subset of these groups have their labels modifying to insert the fairness bias into the trained model as further described below.

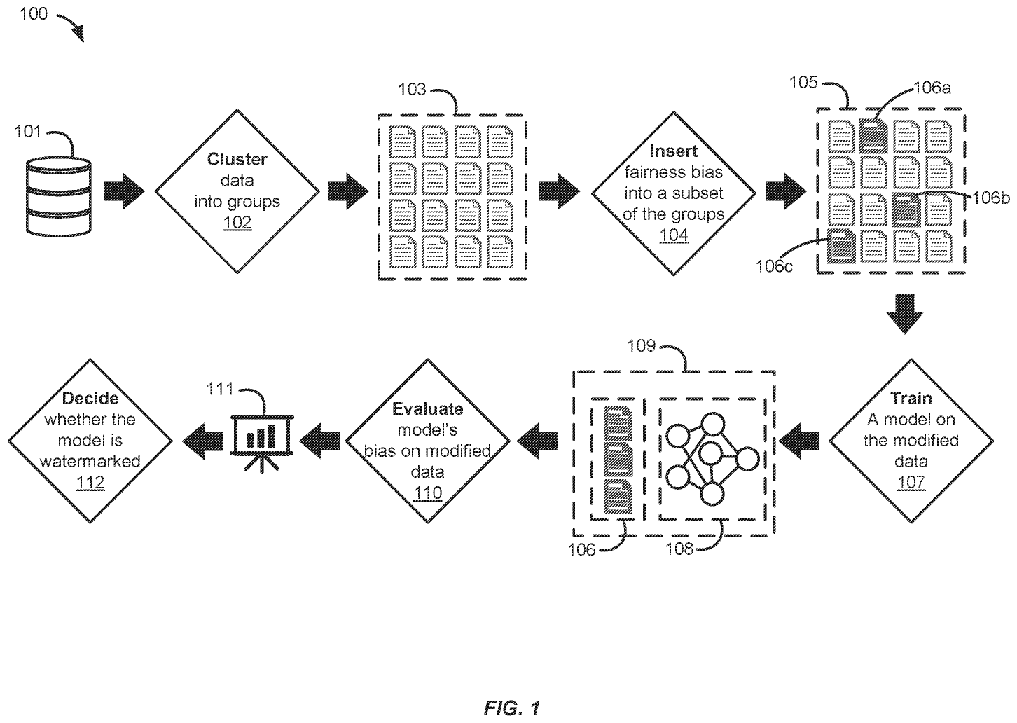

FIG. 1 shows a diagram 100 of watermark embedding, machine learning model training, and watermark evaluation, according to an embodiment. To begin, labeled data 101 is clustered 102 into several groups 103. The clustering algorithm used at 102 may be secret and only known to the model owner.

Then, at 104 fairness bias is intentionally inserted into a subset including 106a, 106b, and 106c of these data groups 105. The number of groups in the subset may be predetermined.

At 107 a machine learning model 108 (e.g., a classification model) is trained on the modified training data, which includes the subsets 106 into which fairness bias was inserted. Thus, the trained machine learning model exhibits the fairness bias inserted into the particular subsets which is a watermark of model ownership. The model 108 and subsets 106 may be used as watermark-verification information 109 for verifying whether other models have the watermark. Techniques for inserting fairness bias are further described below.

As mentioned above, the model owner may use this watermark to determine whether they own other machine learning models (e.g., whether their own model has been stolen and is being provided by someone else). During a later verification phase, the model's owner may evaluate at 110 the fairness bias in the previously modified data groups. The model owner may observe at 111 a fairness bias in the other model and the model's owner can decide at 112 whether or not the model was stolen by comparing the observed bias in the other model to the inserted bias in their own model.

By design, the model owner is able to identify its model if the inserted bias is recognized in the model's outputs. Thus, without introducing additional data, as opposed to backdoor-based watermarking, fairness-based watermarking is not vulnerable to multiple verification queries. Advantageously, the watermark is secret by virtue of the secrecy of the clustering algorithm.

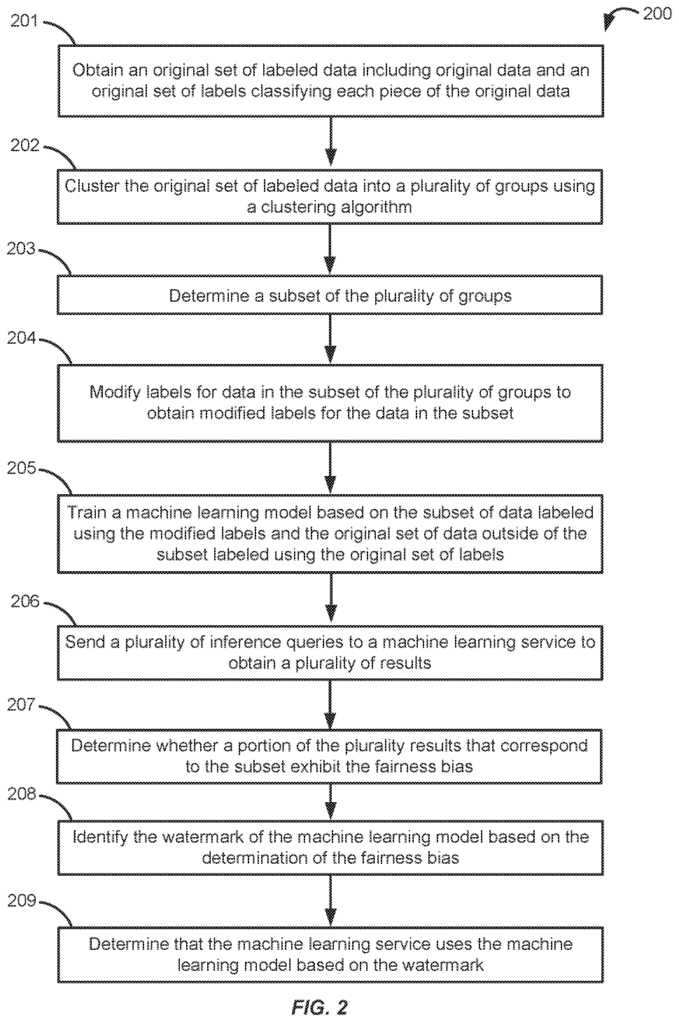

The clustering of groups, the insertion of the fairness bias, and the verification are further described below with respect to FIGS. 2-4.

FIG. 2 shows a diagram 200 of a method for embedding and verifying a watermark using fairness bias, according to an embodiment. The embedding of the watermark and training of the model are performed in 201-205 while verification of the watermark is performed in 206-209.

At 201, obtain an original set of labeled data including original data and an original set of labels classifying each piece of the original data. This labeled data will be modified and then used to train the machine learning model.

At 202, cluster the original set of labeled data into a plurality of groups using a clustering algorithm. The clustering algorithm is unique and deterministic, and it is kept secret by the model owner.

At 203, determine a subset of the plurality of groups. This determination of the subset of the plurality of groups fairness bias may be based on ordering the plurality of groups based on a corresponding fairness bias of each group.

At 204, modify labels for data in the subset of the plurality of groups to obtain modified labels for the data in the subset. The modifying of the labels for data in the subset inserts fairness bias into the subset. The fairness bias may be based on a disparate impact metric. The modifying of the labels for data in the subset may be based on a sensitivity bias.

At 205, train a machine learning model based on the subset of data labeled using the modified labels and the original set of data outside of the subset labeled using the original set of labels. The machine learning model may be a binary classifier or a multi-class classifier. The machine learning model exhibits the fairness bias when classifying input data belonging to subset of the plurality of groups. This exhibiting of the fairness bias for input data belonging to the subset is a watermark of the machine learning model that was trained using the modified labels for the subset determined based on the subgroup algorithm.

After a machine learning model with a watermark has been created, it may be verified whether other machine learning models offered by machine learning services have that watermark.

At 206, send a plurality of inference queries to a machine learning service to obtain a plurality of results. The plurality of inference queries may be sent to an application programming interface endpoint of the machine learning service. The plurality of inference queries include query data belonging to the subset of the plurality of groups.

At 207, determine whether a portion of the plurality results that correspond to the subset exhibit the fairness bias. This determination may be made based on an accuracy of the results.

At 208, identify the watermark of the machine learning model based on the determination of the fairness bias.

At 209, determine that the machine learning service uses the machine learning model based on the watermark. Thus, the model owner may determine whether other machine learning services are using their machine learning model that they trained and which includes their watermark.

### Examples

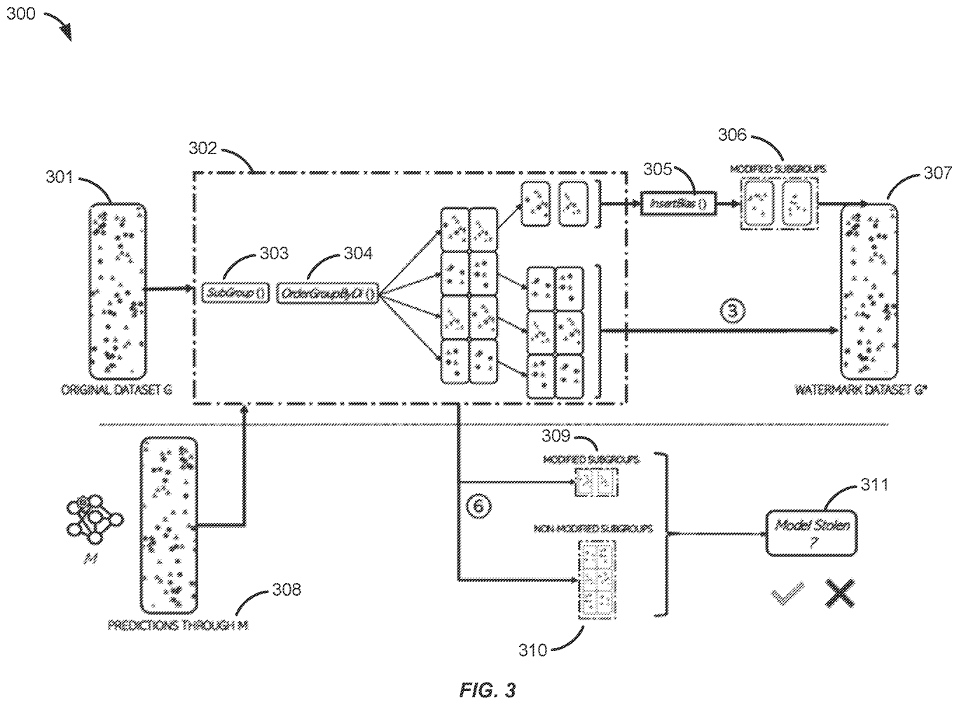

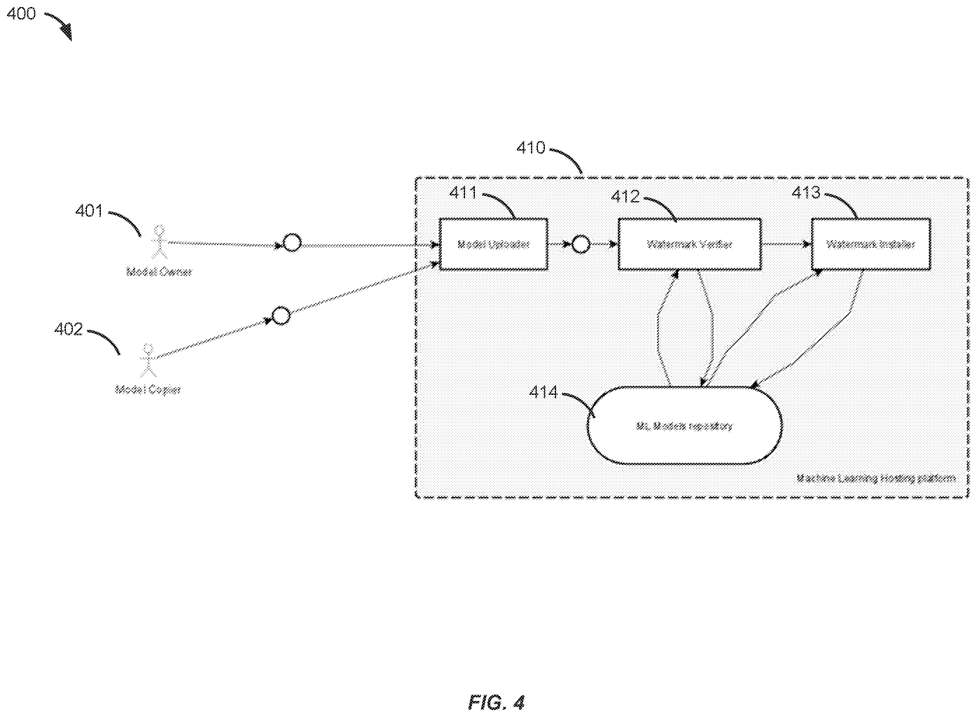

FIGS. 3 and 4 provide examples of machine learning watermarking and verification.

FIG. 3 shows a diagram 300 of a machine learning model watermarking algorithm including an embedding phase 301-307 and a verification phase 308-311, according to an embodiment.

In this example, a fairness bias inserted into a model is considered as a measure of performance, where a model predicts differently for different groups within the data. Some groups can be considered as sensitive (such as race, gender or age). Thus, fairness bias is usually undesirable to avoid discriminating behavior in the model. Evaluating the fairness of a model may consist of comparing the behavior of the model on specific subgroups of inputs with the behavior of the model on the overall data. In some embodiments, a specific definition of fairness bias is used called Disparate Impact (DI). For a binary classifier M and an inference dataset L, the Disparate Impact evaluates the ratio between positive output in a subgroup G of L, called privileged group, and the positive output in the remaining dataset L\G:

$$DI ( G ) = \frac{P ( \hat{Y} = 1 ) x ∈ L ∖ G}{P ( \hat{Y} = 1 ) x ∈ G}$$

Herein, the following notation is used for simplicity:

$$DI ( G ) = \frac{s G}{p}$$

If DI(G)=1, that means M does not have a fairness bias (in the sense of Disparate Impact) towards G.

The Embedding algorithm may be used to insert fairness bias to some selected subgroups. More specifically, Algorithm 1, below, takes four parameters provided by the model owner as inputs: the number of modified subgroups n∈N, the sensitivity of the inserted biases s∈[0, 1], the subgroup labeling algorithm SubGroup and the legitimate data L=(X,Y).

The subgroup labeling algorithm generation is defined as SubGroup: X-> [symbol] ^{z} as a function which takes as input x∈X and associates the corresponding group label y∈ [symbol] ^{z}. The SubGroup algorithm or function may be unique, deterministic, and secret (e.g., only known by the model owner). By analogy, SubGroup corresponds to the trigger generation algorithm in backdoor-based watermarking. However, instead of generating trigger inputs through a secret generation algorithm, the SubGroup algorithm can select specific subgroups belonging to the training dataset and to modify the behavior of the watermarked model on these precise subgroups.

The embedding algorithm (algorithm 1), the insert bias algorithm (Algorithm 2), and the verification algorithm (Algorithm 3) are presented below.

Algorithm 1 Embedding

| 1: | L: set of inputs/outputs | |
|---|---|---|
| 2: | SubGroup: subgroup algorithm | |
| 3: | n: number of modified subgroups. | |
| 4: | s: sensitivity of the bias. | |
| 5: | procedure Embedding | |
| 6: | groups ←SubGroup(X) | [symbol] Split data in groups |
| 7: | G ←GroupBy(groups) | |
| 8: | for each G, g_{id} in G do | |
| 9: | D_{G} ← DI (G_{Y} , G_{Y} \ G_{Y} ) | |
| 10: | end for | |
| 11: | OrderGroupByDI (∪ D_{G}) | |
| 12: | G* ← ø | |
| 13: | k ← 0 | |
| 14: | for each G, g_{id} in G do | |
| 15: | if k < n then | |
| 16: | G, sG ← InsertBias (s, G, G \ G, n) | |
| 17: | lG ← g_{id} | [symbol] Store group id |
| 18: | G* ← G ∪ G* | [symbol] Update training data |

| | |
|---|---|
| 19: | k ←k + 1 |
| 20: | else |
| 21: | G* ←G ∪ G* |
| 22: | end if |
| 23: | end for |
| 24: | l_{refs} ← ∪ lG |
| 25: | s_{refs} ← ∪ sG |
| 26: | return G*, s_{refs} , l_{refs} [symbol] Return Updated data, inserted biases and group ids |
| 27: | end procedure |

Algorithm 2 InsertBias

| | |
|---|---|
| 1: | s: sensitivity |
| 2: | G: subgroup to be modified |
| 3: | G \ G: complete training data except G |
| 4: | n: number of modified subgroups. |
| 5: | procedure InsertBias |
| 6: | target ←random(0, 1) |
| 7: | if mode == ’FULL’ then |
| 8: | for each x,y in G do |
| 9: | if random( ) < s then |
| 10: | y ←target |
| 11: | end if |
| 12: | end for |
| 13: | else |
| 14: | ANCHOR(s, target ) |
| 15: | end if |
| 16: | sG, p ← DI (G, G \ G) |
| 17: | return G, sG |
| 18: | end procedure |

Algorithm 3 Verification

| | |
|---|---|
| 1: | SubGroup: subgroup algorithm |
| 2: | s_{refs} : inserted biases |
| 3: | l_{refs} : modified subgroups ids |
| 4: | M: Suspect model |
| 5: | X: Input queries |
| 6: | procedure Verify |
| 7: | r ← M(X) |
| 8: | groups ←SubGroup(X) |
| 9: | G, g_{id} ←GroupBy(groups) |
| 10: | for each G, g_{id} in G do |
| 11: | if g_{id} ϵ l_{refs} then |
| 12: | rG ←r _{[groups==gid]} |
| 13: | D_{G} ← DI (r_{G}, r \ r_{G}) |
| 14: | end if |
| 15: | end for |
| 16: | for idx, D_{G} in ∪ D_{G} do |
| 17: | sG ←s_{refs} [idx] |
| 18: | sĜ , p ← D_{G} |
| 19: | acc_{G} ←Accuracy(D_{G}, sG, sĜ ) |
| 20: | end for |
| 21: | return ∪ acc_{G} / \|_{lrefs} \| |
| 22: | end procedure |

The Embedding algorithm is described as follows:

The list of group labels for each input groups is computed, then grouped by label and stored in G, through the function GroupByDI.

For each subgroup G∈G with the corresponding group id g_{id}, compute the disparate impact D_{G} of the subgroup compared to the overall data, to evaluate how naturally the subgroup is biased towards 1. D_{G}=1 means that elements belonging to G behave similarly to elements not belonging to G (i.e there is no bias in the data against or in favor of G).

The subgroups G are ordered by value of |1−D_{G}|, i.e from the less biased (or neutral) to the most biased (towards 0 or 1), through the function OrderGroupByDI.

For a given number n of subgroups G*∈G, called modified subgroups, embed a bias into each subgroup, according to the bias sensitivity parameter s using the algorithm InsertBias( ) with two possible modes: FULL or ANCHOR, and is described later.

The Embedding algorithm returns data with embedded bias G*. alongside with the ownership information: the modified subgroups ids l_{refs} with corresponding bias sensitivities s_{refs}.

After the Embedding phase, the machine learning algorithm is trained on the biased data G*, and considered as watermarked after the training phase.

The ability to insert a fairness bias in each subgroup of data can follow two strategies. The first strategy, denoted FULL, consists in modifying the labels of the elements of the subgroup, proportionally to a sensitivity bias s. The FULL algorithm selects a proportion of s elements in the subgroup, then modify the labels according to a pre-defined bias called target in Algorithm 2 (towards 0 or 1).

Although FULL may not require additional data generation (only outputs are modified), it may impact the data and hence, the accuracy of the watermarked model trained on this data. The second strategy, denoted ANCHOR, distorts the watermarked model's decision boundary by generating “poisoned points” near specific target points to bias (proportionally to a sensitivity bias s) the outcome. As opposed to FULL, ANCHOR works as a data augmentation process and generates additional data points.

In the Verification phase, a model is assessed for the fairness bias inserted by the model owner in order grant or deny the ownership of the model. The Verification phase (Algorithm 3) takes five parameters as inputs: the subgroup labeling algorithm used in the Embedding phase SubGroups( ) the labels of modified subgroups l_{refs}, the corresponding bias sensitivities s_{refs} inserted, the suspect model to verify M and the legitimate input data X.

In verification, the model owner sends inference queries X to obtain prediction results r. Similarly to the Embedding phase, the list of group labels for each input groups is computed, then these are grouped by label and stored in G. For each group label, verify if the subgroup was supposed to be modified in the Embedding. If it is the case, then predictions results related to this particular subgroup are extracted, in order to compute the disparate impact of the subgroup compared to the overall data. For each modified subgroup, compute the accuracy of the watermark of the suspect model, based on the measured disparate impact D_{G}, the sensitivity of the inserted bias in the Embedding phase sG and the sensitivity of the overall bias in the training data, to the exception of G. sĜ. Finally, the average of the accuracy on each modified subgroup is returned.

Information of ownership O is defined as:

O={SubGroup, s_{refs}, l_{refs}}

O is kept secret, only known by the model owner and used in the verification algorithm, alongside the suspect model M and legitimate data X. As opposed to backdoor-based watermarking models the query does not need to be secret, the only secret information is the subgroups distribution.

As discussed above, a model owner may use the watermark to determine whether they own a particular machine learning model being used by someone else. This ownership verification may also be offered by a machine learning hosting platform.

FIG. 4 shows a diagram 400 of a machine learning platform 410 that installs and verifies machine learning model watermarks, according to an embodiment. The machine learning hosting platform 410 is a platform that hosts and provides access to machine learning models stored in a machine learning (ML) model repository 414. The machine learning hosting platform 410 may enable users to share their models by uploading their model to a model uploader component 411. The models can then be stored with a restricted or open access via an API for a remote consumption. The ML hosting platform 410 can also be connected with other hosting platforms in order to share and verify models' watermarks hosted in these platforms.

The ML Model repository 414 is a storage component configured to persist the different machine learning models uploaded and copied to the platform 410. It can be a database or any other storage device able to persist ML models.

The machine learning hosting platform 410 also includes a watermark verifier component 412. This component is configured to verify the presence and the value of a watermark contained in a new model to be stored in the platform. If the model is already watermarked, verify the watermark, and reject the new model if the watermark was already registered.

The machine learning hosting platform also includes a watermark installer component 413 which is configured to insert a watermark using the fairness bias watermarking techniques described above. This component is further configured to a new watermarks to non-watermarked models.

An example is now provided with respect to a model owner 401, who is the original owner of the model that registers first his model to the platform, and a model copier 402, who is a malicious actor that wants to register an already registered watermarked model.

As one example, ACME Model store is a machine learning hosting platform that offers the service of providing pre-trained machine learning models to be consumed by their customers via an open and restricted API. Every customer can publish his watermarked model to this platform, and if the customer's model is not watermarked, the ACME model store offers the possibility to add a “watermark through fairness bias” to protect this model. The company Wine Inc. want to share its brand-new wine quality analysis model. They submitted their watermarked model to the platform. Their watermarked model is verified then stored in the platform ready to be used by other customers. BadWine Inc. the competitor of Wine Inc. was able to get a copy of this watermarked model, and they want to commercially exploit it. They modified a bit the model by adding a new dataset then they submitted the modified copy of the model to the ACME Model store platform, after the verification process the Watermark verifier service identified the original watermark and rejected the submission. BadWine Inc. decided to submit the model to other ML hosting platforms, but they all identified the registered watermark. BadWine decided to try to identify the watermark added to the original model but there is no way to guess the bias.

In this way a machine learning model can be watermarked using the fairness bias technique described above and ownership of such a model can be determined by identifying the watermark based on a fairness bias observed in results obtained from machine learning models.

### Example Hardware

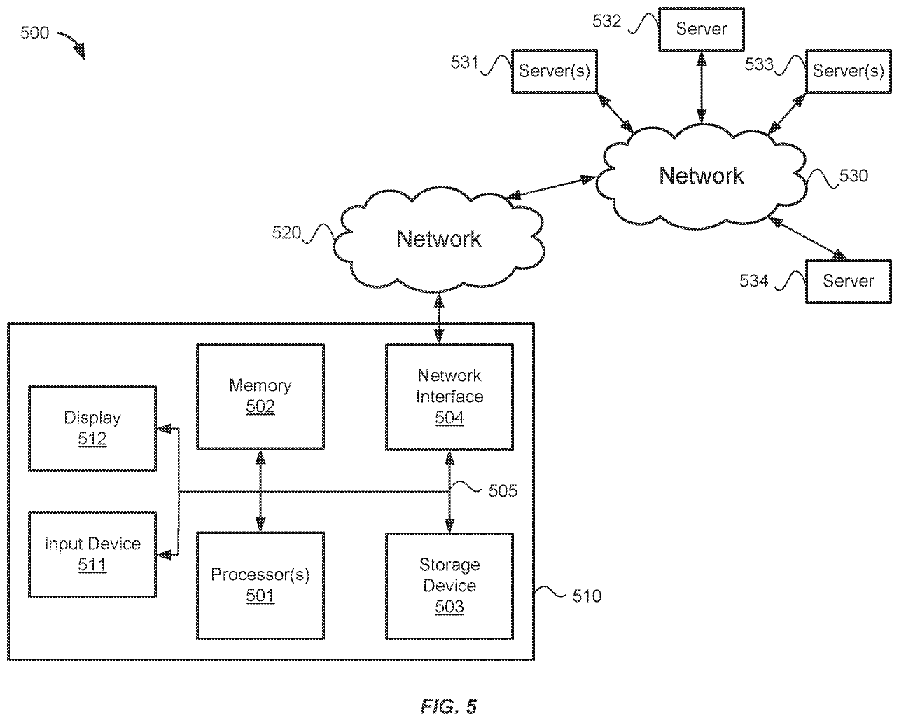

FIG. 5 shows a diagram 500 of hardware of a special purpose computing machine for implementing systems and methods described herein. The following hardware description is merely one example. It is to be understood that a variety of computers topologies may be used to implement the above described techniques. The hardware shown in FIG. 5 may be used to implement the computer systems and computer software (computer reprogram code) described herein.

The computer system 510 includes a bus 505 or other communication mechanism for communicating information, and one or more processor(s) 501 coupled with bus 505 for processing information. The computer system 510 also includes a memory 502 coupled to bus 505 for storing information and instructions to be executed by processor 501, including information and instructions for performing some of the techniques described above, for example. This memory may also be used for storing programs executed by processor(s) 501. Possible implementations of this memory may be, but are not limited to, random access memory (RAM), read only memory (ROM), or both. A storage device 503 is also provided for storing information and instructions. Common forms of storage devices include, for example, a hard drive, a magnetic disk, an optical disk, a CD-ROM, a DVD, a flash or other non-volatile memory, a USB memory card, or any other medium from which a computer can read. Storage device 503 may include source code, binary code, or software files for performing the techniques above, for example. Storage device and memory are both examples of non-transitory computer readable storage mediums.

The computer system 510 may be coupled via bus 505 to a display 512 for displaying information to a computer user. An input device 511 such as a keyboard, touchscreen, and/or mouse is coupled to bus 505 for communicating information and command selections from the user to processor 501. The combination of these components allows the user to communicate with the system. In some systems, bus 505 represents multiple specialized buses, for example.

The computer system also includes a network interface 504 coupled with bus 505. The network interface 504 may provide two-way data communication between computer system 510 and a network 520. The network interface 504 may be a wireless or wired connection, for example. The network 520 may be a local area network or an intranet, for example. The computer system 510 can send and receive information through the network interface 504, across the network 520, to computer systems connected to the Internet 530. Using the Internet 530 the computer system 510 may access data and features that reside on multiple different hardware servers 531-534. The servers 531-534 may be part of a cloud computing environment in some embodiments.

### Example Embodiments

Various example embodiments implementing the techniques discussed above are described below.

Some embodiments provide a computer system. The computer system comprises one or more processors and one or more machine-readable medium coupled to the one or more processors. The one or more machine-readable medium storing computer program code comprising sets instructions executable by the one or more processors to obtain an original set of labeled data including original data and an original set of labels classifying each piece of the original data. The instructions being further executable by the one or more processors to cluster the original set of labeled data into a plurality of groups using a clustering algorithm. The instructions being further executable by the one or more processors to determine a subset of the plurality of groups. The instructions being further executable by the one or more processors to modify labels for data in the subset of the plurality of groups to obtain modified labels for the data in the subset. The modifying of the labels for data in the subset inserts fairness bias into the subset. The instructions being further executable by the one or more processors to train a machine learning model based on the subset of data labeled using the modified labels and the original set of data outside of the subset labeled using the original set of labels. The machine learning model will exhibit the fairness bias when classifying input data belonging to subset of the plurality of groups. This exhibiting of the fairness bias for input data belonging to the subset is a watermark of the machine learning model that was trained using the modified labels for the subset.

In some embodiments of the computer system, the instructions are further executable by the one or more processors to send a plurality of inference queries to a machine learning service to obtain a plurality of results. The plurality of inference queries include query data belonging to the subset of the plurality of groups. The instructions being further executable by the one or more processors to determine whether a portion of the plurality results that correspond to the subset exhibit the fairness bias. The instructions being further executable by the one or more processors to identify the watermark of the machine learning model based on the determination of the fairness bias. The instructions being further executable by the one or more processors to determine that the machine learning service uses the machine learning model based on the watermark.

In some embodiments of the computer system, the fairness bias is based on a disparate impact metric.

In some embodiments of the computer system, the determination of the subset of the plurality of groups fairness bias is based on ordering the plurality of groups based on a corresponding fairness bias of each group.

In some embodiments of the computer system, the clustering algorithm is unique and deterministic.

In some embodiments of the computer system, the modifying labels for data in the subset is based on a sensitivity bias.

In some embodiments of the computer system, the machine learning model is a binary classifier or a multi-class classifier.

Some embodiments provide a non-transitory computer-readable medium storing computer program code. The computer program code comprises sets of instructions to obtain an original set of labeled data including original data and an original set of labels classifying each piece of the original data. The computer program code further comprises sets of instructions to cluster the original set of labeled data into a plurality of groups using a clustering algorithm. The computer program code further comprises sets of instructions to determine a subset of the plurality of groups. The computer program code further comprises sets of instructions to modify labels for data in the subset of the plurality of groups to obtain modified labels for the data in the subset. The modification of the labels for data in the subset inserting fairness bias into the subset. The computer program code further comprises sets of instructions to train a machine learning model based on the subset of data labeled using the modified labels and the original set of data outside of the subset labeled using the original set of labels. The machine learning model will exhibit the fairness bias when classifying input data belonging to subset of the plurality of groups. The exhibiting of the fairness bias for input data belonging to the subset is a watermark of the machine learning model that was trained using the modified labels for the subset.

In some embodiments of the non-transitory computer-readable medium, the computer program code further comprises sets of instructions to send a plurality of inference queries to a machine learning service to obtain a plurality of results. The plurality of inference queries include query data belonging to the subset of the plurality of groups. The computer program code further comprises sets of instructions to determine whether a portion of the plurality results that correspond to the subset exhibit the fairness bias. The computer program code further comprises sets of instructions to identify the watermark of the machine learning model based on the determination of the fairness bias. And the computer program code further comprises sets of instructions to determine that the machine learning service uses the machine learning model based on the watermark.

In some embodiments of the non-transitory computer-readable medium, the fairness bias is based on a disparate impact metric.

In some embodiments of the non-transitory computer-readable medium, determination of the subset of the plurality of groups fairness bias is based on ordering the plurality of groups based on a corresponding fairness bias of each group.

In some embodiments of the non-transitory computer-readable medium, the clustering algorithm is unique and deterministic.

In some embodiments of the non-transitory computer-readable medium, the modifying labels for data in the subset is based on a sensitivity bias.

In some embodiments of the non-transitory computer-readable medium, the machine learning model is a binary classifier or a multi-class classifier.

Some embodiments provide a computer-implemented method. The method comprises obtaining an original set of labeled data including original data and an original set of labels classifying each piece of the original data. The method further comprises clustering the original set of labeled data into a plurality of groups using a clustering algorithm. The method further comprises determining a subset of the plurality of groups. The method further comprises modifying labels for data in the subset of the plurality of groups to obtain modified labels for the data in the subset. The modifying of the labels for data in the subset inserts fairness bias into the subset. The method further comprises training a machine learning model based on the subset of data labeled using the modified labels and the original set of data outside of the subset labeled using the original set of labels. The machine learning model exhibits the fairness bias when classifying input data belonging to subset of the plurality of groups. The exhibiting of the fairness bias for input data belonging to the subset is a watermark of the machine learning model that was trained using the modified labels for the subset.

In some embodiments of the method, the method further comprises sending a plurality of inference queries to a machine learning service to obtain a plurality of results. The plurality of inference queries include query data belonging to the subset of the plurality of groups. The method further comprises determining whether a portion of the plurality results that correspond to the subset exhibit the fairness bias. The method further comprises identifying the watermark of the machine learning model based on the determination of the fairness bias. The method further comprises determining that the machine learning service uses the machine learning model based on the watermark.

In some embodiments of the method, the fairness bias is based on a disparate impact metric.

In some embodiments of the method, the determination of the subset of the plurality of groups fairness bias is based on ordering the plurality of groups based on a corresponding fairness bias of each group.

In some embodiments of the method, the clustering algorithm is unique and deterministic.

In some embodiments of the method, the modifying labels for data in the subset is based on a sensitivity bias.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations, and equivalents may be employed without departing from the scope of the present disclosure as defined by the claims.

What is claimed is:

1. A computer system, comprising:
one or more processors;
one or more machine-readable medium coupled to the one or more processors and storing computer program code comprising sets instructions executable by the one or more processors to:
obtain an original set of labeled data including original data and an original set of labels classifying each piece of the original data;
cluster the original set of labeled data into a plurality of groups using a clustering algorithm;
determine a subset of the plurality of groups;
modify labels for data in the subset of the plurality of groups to obtain modified labels for the data in the subset, the modifying of the labels for data in the subset inserting fairness bias into the subset; and
train a machine learning model based on the subset of data labeled using the modified labels and the original set of data outside of the subset labeled using the original set of labels, wherein the machine learning model exhibits the fairness bias when classifying input data belonging to subset of the plurality of groups, the exhibiting of the fairness bias for input data belonging to the subset being a watermark of the machine learning model that was trained using the modified labels for the subset.

2. The computer system of claim 1, wherein the computer program code further comprises sets of instructions executable by the one or more processors to:
send a plurality of inference queries to a machine learning service to obtain a plurality of results, the plurality of inference queries including query data belonging to the subset of the plurality of groups;
determine whether a portion of the plurality results that correspond to the subset exhibit the fairness bias;
identify the watermark of the machine learning model based on the determination of the fairness bias; and
determine that the machine learning service uses the machine learning model based on the watermark.

3. The computer system of claim 1, wherein the fairness bias is based on a disparate impact metric.

4. The computer system of claim 1, wherein the determination of the subset of the plurality of groups fairness bias is based on ordering the plurality of groups based on a corresponding fairness bias of each group.

5. The computer system of claim 1, wherein the clustering algorithm is unique and deterministic.

6. The computer system of claim 1, wherein the modifying labels for data in the subset is based on a sensitivity bias.

7. The computer system of claim 1, wherein the machine learning model is a binary classifier or a multi-class classifier.

8. A non-transitory computer-readable medium storing computer program code comprising sets of instructions to:
obtain an original set of labeled data including original data and an original set of labels classifying each piece of the original data;
cluster the original set of labeled data into a plurality of groups using a clustering algorithm;
determine a subset of the plurality of groups;
modify labels for data in the subset of the plurality of groups to obtain modified labels for the data in the subset, the modifying of the labels for data in the subset inserting fairness bias into the subset; and
train a machine learning model based on the subset of data labeled using the modified labels and the original set of data outside of the subset labeled using the original set of labels, wherein the machine learning model exhibits the fairness bias when classifying input data belonging to subset of the plurality of groups, the exhibiting of the fairness bias for input data belonging to the subset being a watermark of the machine learning model that was trained using the modified labels for the subset.

9. The non-transitory computer-readable medium of claim 8, wherein the computer program code further comprises sets of instructions to:
send a plurality of inference queries to a machine learning service to obtain a plurality of results, the plurality of inference queries including query data belonging to the subset of the plurality of groups;
determine whether a portion of the plurality results that correspond to the subset exhibit the fairness bias;
identify the watermark of the machine learning model based on the determination of the fairness bias; and
determine that the machine learning service uses the machine learning model based on the watermark.

10. The non-transitory computer-readable medium of claim 8, wherein the fairness bias is based on a disparate impact metric.

11. The non-transitory computer-readable medium of claim 8, wherein the determination of the subset of the plurality of groups fairness bias is based on ordering the plurality of groups based on a corresponding fairness bias of each group.

12. The non-transitory computer-readable medium of claim 8, wherein the clustering algorithm is unique and deterministic.

13. The non-transitory computer-readable medium of claim 8, wherein the modifying labels for data in the subset is based on a sensitivity bias.

14. The non-transitory computer-readable medium of claim 8, wherein the machine learning model is a binary classifier or a multi-class classifier.

15. A computer-implemented method, comprising:
obtaining an original set of labeled data including original data and an original set of labels classifying each piece of the original data;
clustering the original set of labeled data into a plurality of groups using a clustering algorithm;
determining a subset of the plurality of groups;
modifying labels for data in the subset of the plurality of groups to obtain modified labels for the data in the subset, the modifying of the labels for data in the subset inserting fairness bias into the subset; and
training a machine learning model based on the subset of data labeled using the modified labels and the original set of data outside of the subset labeled using the original set of labels, wherein the machine learning model exhibits the fairness bias when classifying input data belonging to subset of the plurality of groups, the exhibiting of the fairness bias for input data belonging to the subset being a watermark of the machine learning model that was trained using the modified labels for the subset.

16. The computer-implemented method of claim 15, further comprising:
sending a plurality of inference queries to a machine learning service to obtain a plurality of results, the plurality of inference queries including query data belonging to the subset of the plurality of groups;
determining whether a portion of the plurality results that correspond to the subset exhibit the fairness bias;
identifying the watermark of the machine learning model based on the determination of the fairness bias; and
determining that the machine learning service uses the machine learning model based on the watermark.

17. The computer-implemented method of claim 15, wherein the fairness bias is based on a disparate impact metric.

18. The computer-implemented method of claim 15, wherein the determination of the subset of the plurality of groups fairness bias is based on ordering the plurality of groups based on a corresponding fairness bias of each group.

19. The computer-implemented method of claim 15, wherein the clustering algorithm is unique and deterministic.

20. The computer-implemented method of claim 15, wherein the modifying labels for data in the subset is based on a sensitivity bias.
